(19) United States
(12) Patent Application Publication
(10) Pub. No.: US 2006/0070477 A1
(43) Pub. Date: Apr. 6, 2006

(54) Adaptive wheelchair joystick

(76) Inventor: Roger Serzen, Sandy, UT (US)

Correspondence Address: THORPE NORTH & WESTERN, LLP., 8180 SOUTH 700 EAST, SUITE 200, SANDY, UT, 84070, US

(21) Appl. No.: 11/243,480

(22) Filed: Oct. 3, 2005

Related U.S. Application Data
(60) Provisional application No. 60/615,754, filed on Oct. 4, 2004.

(51) Int. Cl. G05G 11/00

(52) U.S. Cl. 74/488

(57) ABSTRACT

An adaptive wheelchair joystick comprising: (a) means for operably coupling the joystick to the control components of a motorized wheelchair; (b) a handle operable with the means for coupling, wherein the handle is configured to support an extremity of a user of the wheelchair and to facilitate manipulation of the adaptive wheelchair joystick; (c) a first tower extending from a first end of the handle; (d) a second tower extending from a second end of the handle, wherein the first and second towers provide lateral support to the extremity of the user; (e) a retention strap releasably secured between the first and second towers to restrict the upward lift of the extremity of the user; and (f) a thumb rest extending from the handle and configured to receive and support a thumb of the user, wherein the thumb rest also facilitates the manipulation of the adaptive wheelchair joystick.

### RELATED APPLICATIONS

This application claims priority to U.S. Provisional Application Ser. No. 60/615,754, filed Oct. 4, 2004, and entitled, “Adaptive Wheelchair Joystick,” which is incorporated by reference in its entirety herein.

### FIELD OF THE INVENTION

This invention relates to methods and devices designed to facilitate the operation of motorized wheelchairs, and more particularly to an adaptive wheelchair joystick or joystick handle configured to provide an improved user interface for controlling the operation and movement of a motorized vehicle, such as a motorized wheelchair.

### BACKGROUND OF THE INVENTION AND RELATED ART

Various advancements in motorized vehicle, namely motorized wheelchair, technology have enabled many users of these wheelchairs to be more independent, wherein the user is able to manipulate or control the movements of the wheelchair as desired without assistance from another. The implementation of motors, such as electric motors, steering mechanisms, and other automated systems have all contributed to the advanced operation of the wheelchair for the handicapped person. Despite these advancements, challenges still are encountered or presented in providing a suitable interface between the user and the control components of the wheelchair designed to control the operation of its automated systems.

One such interface device is a single stem joystick that is vertically oriented and attached to a support, such as an arm rest. The single stem joystick is operable with the various components of the wheelchair to allow the user to control the movements of the wheelchair by manipulating the components via manipulation of the joystick accordingly. While the single stem joystick is simple in design and provides an adequate control interface, there are several inherent problems associated with this type of interface device. Because there is only a single stem involved, the user must have the dexterity required to grasp and manipulate the joystick as intended. However, this is often not the case with moderate to severe handicapped individuals. Grasping and trying to control a single stem joystick can be frustrating for an individual who has lost some or most of his or her motor skills. In addition, it is easy for the hand of a user to slip off of the single stem joystick during operation as the joystick provides no support to the hand or arm of the user. For instance, going over a small bump can cause the user to lose his or her grip on the joystick. Moreover, bumps and other obstacles can jolt or throw the wheelchair in an unexpected manner, which may lead to inadvertent manipulation of the joystick by the user and a resulting inadvertent command to the wheelchair that can cause the user to lose control for a period of time. Another deficiency is that the joystick requires a higher degree of dexterity or a higher degree of motor skills to operate as fine movements of the joystick may translate into wheelchair response. Those with adequate motor skills may feel fine in using this type of interface device, but it may be difficult and frustrating for those who have lost a significant portion of their motor skills.

Another type of interface device incorporates a handle with two towers rising vertically from each end. This handle-type joystick further comprises a member configured to interface with the control components of the wheelchair in a similar manner as the single stem joystick. However, the handle-type joystick provides significant improvement over the single stem joystick in that it is more ergonomically correct for the user, and requires less motor skills to manipulate. The handle serves as the primary interface for the user, with the towers providing additional support and functioning as secondary interface components. The user can grasp the handle and manipulate the joystick via the handle, or the user can apply a force to the towers to assist the user in manipulating the joystick. Thus, the towers function to assist the user in controlling the movements of the wheelchair. The towers further act as barriers that prevent the user from slipping off of the handle when negotiating one or more wheelchair movements.

Despite its advantages, one of the problems with the handle-type joystick just described, which is also a problem with the single stem joystick, is its inability to support or secure the hand during operation. Indeed, although the user may have a difficult time slipping off of the handle in a lateral direction due to the presence of the towers, the user may easily slip forward or backward as there is no additional restraint of the hand. Furthermore, as in the single stem joystick, the user is required to have a relatively high degree of dexterity to maintain grip on the handle and to manipulate the joystick as there is nothing to assist the user in maintaining his or her grip. Though not as much dexterity is required for the handle-type joystick as the single stem joystick, this is still a problem for many users. Finally, the handle may be uncomfortable and difficult to manipulate as it is only a slight ergonomic improvement over the single stem joystick.

As such, both the single stem joystick and the handle-type joystick as described above both lack sufficient assistive features that would assist the user in manipulation of the joystick, and therefore control of the wheelchair movements. In addition, both lack the ability to provide a secure and comfortable interface device that is as easy for the less capable to operate as it is for those with good dexterity.

### SUMMARY OF THE INVENTION

In light of the problems and deficiencies inherent in the prior art, the present invention seeks to overcome these by providing an adaptive wheelchair joystick that comprises various assistive features that assist the user in manipulation of the joystick, as well as means for securing or supporting the hand of the user in a comfortable manner.

In accordance with the invention as embodied and broadly described herein, the present invention features an adaptive wheelchair joystick comprising: (a) means for operably coupling the joystick to the control components of a motorized wheelchair; (b) a handle operable with the means for coupling, wherein the handle is configured to be grasped by or support, as a rest, the hand or extremity of a user of the wheelchair and to facilitate manipulation of the adaptive wheelchair joystick; (c) at least one tower extending from the handle, wherein the tower provides lateral support for the hand or extremity of the user; and (d) a thumb rest extending from the handle and configured to receive and support a thumb of the user, wherein the thumb rest also facilitates the manipulation of the adaptive wheelchair joystick. In one exemplary embodiment, the means for operably coupling comprises an adjustable stem.

The present invention also features an adaptive wheelchair joystick comprising: (a) means for operably coupling the joystick to the control components of a motorized wheelchair; (b) a handle operable with the means for coupling, wherein the handle is configured to be grasped by or support, as a rest, the hand or extremity of a user of the wheelchair and to facilitate manipulation of the adaptive wheelchair joystick; (c) a first tower extending from a first end of the handle; (d) a second tower extending from a second end of the handle, wherein the first and second towers provide lateral support to the hand or extremity of the user; and (e) a retention strap operable with said handle and said first and second towers to restrict the upward lift of the hand of the user and to alter the sensitivity of the joystick in response to movements by the hand or extremity of the user.

The present invention further features an adaptive wheelchair joystick comprising: (a) means for operably coupling the joystick to the control components of a motorized wheelchair; (b) a handle operable with the means for coupling, wherein the handle is configured to be grasped by or support, as a rest, the hand or extremity of a user of the wheelchair and to facilitate manipulation of the adaptive wheelchair joystick; (c) a first tower extending from a first end of the handle; (d) a second tower extending from a second end of the handle, wherein the first and second towers provide lateral support to the hand or extremity of the user; (e) a retention strap operable with said handle and the first and second towers to restrict the upward lift of the hand of the user and to alter the sensitivity of the joystick in response to movements by the hand of the user; and (f) a thumb rest extending from the handle and configured to receive and support a thumb of the user, wherein the thumb rest is also configured to facilitate the manipulation of the adaptive wheelchair joystick.

The present invention still further features a method for controlling the movements of a motorized wheelchair comprising: (a) coupling an adaptive wheelchair joystick to the control components of a motorized wheelchair; (b) interfacing a hand or an extremity with a handle of the adaptive wheelchair joystick located between first and second towers extending from the handle; (c) securing a retention strap between the first and second towers to restrict the upward lift of the hand or extremity of the user and to provide a degree of sensitivity to the adaptive wheelchair joystick in response to movements to the adaptive wheelchair joystick by the user; and (d) manipulating the handle in a variety of ways to initiate a command to the control components, wherein the command causes the wheelchair to move in an intended, pre-determined manner.

The method just described further comprises providing a thumb rest extending from an end of the handle, wherein the thumb rest is configured to receive and support a thumb of the user and to facilitate the manipulation of the adaptive wheelchair joystick.

The method still further comprises adjusting the retention strap to alter the sensitivity of the adaptive wheelchair joystick in response to the movements of the hand of the user.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of an adaptive wheelchair joystick according to one exemplary embodiment of the present invention;

FIG. 2 illustrates a perspective view of an adaptive wheelchair joystick according to another exemplary embodiment of the present invention;

FIG. 3-A illustrates a perspective view of an adaptive wheelchair joystick according to still another embodiment of the present invention;

FIG. 3-B illustrates a perspective view of the adaptive wheelchair joystick of FIG. 2 having a retention strap located in its lowest position between the two towers;

FIG. 3-C illustrates a perspective view of the adaptive wheelchair joystick of FIG. 2 having a retention strap positioned between the two towers so as to be on an angle with respect to the handle;

FIG. 4 illustrates a perspective view of an adaptive wheelchair joystick according to still another exemplary embodiment of the present invention;

FIG. 5 illustrates a perspective view of an adaptive wheelchair joystick according to still another exemplary embodiment of the present invention, wherein the towers are trimmed or otherwise shortened; and

FIG. 6 illustrates a perspective view of an adaptive wheelchair joystick according to still another exemplary embodiment of the present invention, wherein the towers comprise additional stiffening members.

### DETAILED DESCRIPTION OF EXEMPLARY EMBODIMENTS

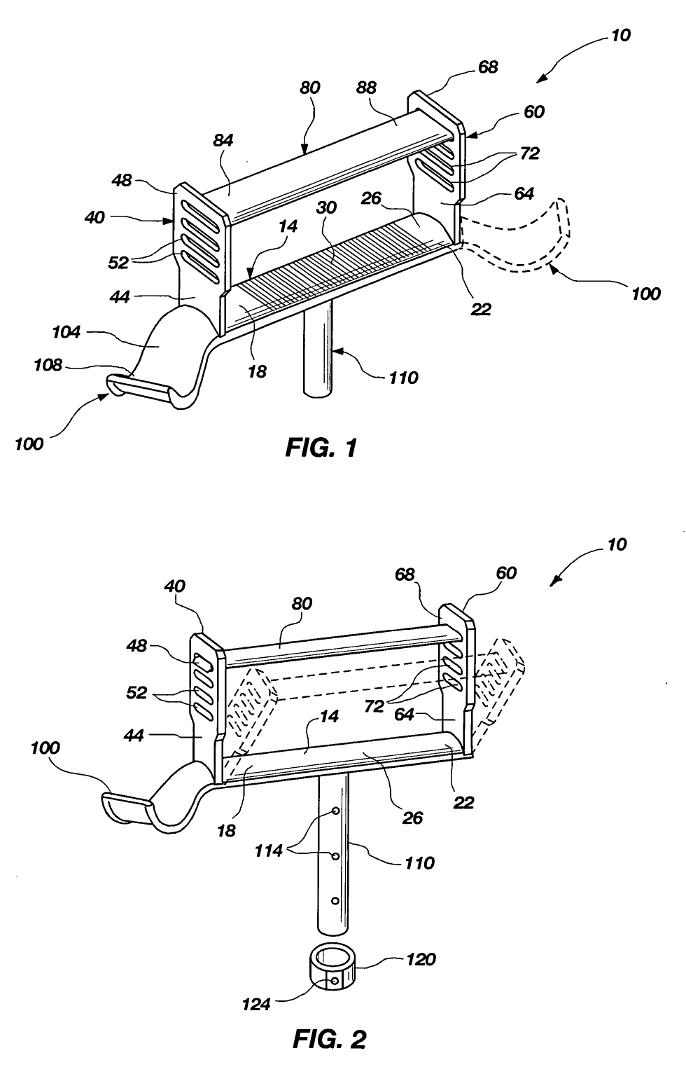

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 6, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention.

Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and device for controlling a motorized wheelchair. Specifically, the present invention describes several embodiments of a device designed to function as the interface component between the user and the control components of a motorized wheelchair. Thus, the present invention features an interface device in the form of an adaptive wheelchair joystick, as well as various methods for using the same, wherein the adaptive wheelchair joystick operably couples to the wheelchair to interface with the control components of the wheelchair providing the user with control over movements of the wheelchair by manipulating the joystick. The adaptive wheelchair joystick is designed to improve prior related devices, such as the single stem joystick and the dual tower joystick, by providing a more ergonomically accommodating or satisfying, functional, and variably sensitive joystick, as well as providing improved securing of the users hand or extremity, thus significantly decreasing the level of dexterity required to manipulate the joystick. Indeed, unlike the single stem joystick that provides no way of securing the hand, that requires the user to grip the joystick at all times, and that is easy to slip off of during operation, the present invention adaptive wheelchair joystick provides various components for securing the hand, for minimizing the need to continuously grip the joystick, and for improving the comfort and feel of an interface device. Similarly, unlike the dual post joystick that offers only lateral support, the present invention adaptive wheelchair joystick is capable of limiting or prohibiting both lateral and lift movements of the user, as well as providing added comfort and control sensitivity. The present invention also improves upon the ergonomics and control characteristics of prior related interface devices through the use of a thumb rest and various design configurations for the handle.

As stated, the adaptive wheelchair joystick interfaces with the control components of a motorized wheelchair to enable the user to control or negotiate wheelchair movements by manipulating the joystick. Thus, in operation, the user of the motorized wheelchair having the adaptive wheelchair joystick of the present invention operably attached thereto manipulates the joystick in one or more ways to initiate one or more commands that are received by the control components of the wheelchair, which commands cause the control components to move the wheelchair in one or more desired ways, such as forwards or backwards, or through various turns. For example, pushing forward on the joystick handle causes the wheelchair to move forward. Pulling back on the handle of the joystick causes the wheelchair to move in reverse. Pivoting the handle of the joystick and the stem downward to the left or right causes the wheelchair to turn. Alternatively, rotating the handle of the joystick about the stem axis can be made to cause the wheelchair to turn. Several of these manipulated actions can be used in combination with one another to negotiate the movement of the wheelchair as desired.

Referring now to FIGS. 1 and 2, illustrated are perspective views of an adaptive wheelchair joystick according to one exemplary embodiment of the present invention. Specifically, FIGS. 1 and 2 illustrate an adaptive wheelchair joystick 10 as comprising a primary handle 14 having a first end 18, a second end 22, and a surface 26. Optionally extending from either or both of first and second ends 18 and 22 of the handle 14 is an assistive feature in the form of a thumb rest 100. Extending in a substantially perpendicular manner from the first end 18 of the handle 14 is an assistive feature in the form of a first tower 40. Likewise, extending in a substantially upward direction from the second end 22 of the handle 14 is an assistive feature in the form of a second tower 60. Optionally extending between first and second towers 40 and 60 is an assistive feature in the form of a retention strap 80 having a first end 84 and a second end 88. In one aspect, the first end 84 of the retention strap 80 may releasably couple to the first tower 40 and the second end 88 may releasably couple to the second tower 60. In another aspect, the first end 84 may releasably couple to a portion of the handle 14 and the second end 88 may couple to another portion of the handle 14. In still another aspect, the retention strap 80 may couple to one of the first and second towers 40 and 60 and a portion of the handle 14. Extending downward from the handle 14 near or at its midsection is means for operably coupling said joystick to the control components of a motorized wheelchair, which is shown in FIG. 1 as stem 110. The stem 110 is configured to operably secure the adaptive wheelchair joystick 10 to a wheelchair (now shown), and particularly to the control components of the wheelchair. The stem 110 may be adjustable or non-adjustable with respect to the wheelchair.

An “assistive feature,” as described herein, is one that assists the user in negotiating wheelchair movements, and more specifically in manipulating the adaptive wheelchair joystick to control the movement of the wheelchair to which the adaptive wheelchair joystick is coupled. An assistive feature may also be one that facilitates certain joystick manipulating actions to be performed by the user.

First tower 40 comprises a riser 44 that couples to the handle 14 at one end and that is integrally formed with an adjustment center 48 at an opposing end. Adjustment center 48 comprises at least one, and preferably a plurality, of locating means configured to receive and position an end 84 of the retention strap 80. Locating means may comprise various forms, which will be apparent to one skilled in the art. As shown in FIG. 1, locating means comprises a plurality of parallel slots 52 formed within the adjustment center 48. Each slot 52 is configured to facilitate the adjustment of the retention strap 80, or to provide a different locating position for the retention strap 80, along the adjustment center 48, thus allowing the retention strap 80 to be adjustably located along the adjustment center 48 of the tower 40 to accommodate different users or to provide selective securing conditions that are the most comfortable or appropriate for the user.

Similarly first tower 40, second tower 60 comprises a riser 64 that couples to the handle 14 at one end and that is integrally formed with an adjustment center 68 at an opposing end. Adjustment center 68 comprises at least one, and preferably a plurality, of locating means configured to receive and position an end 88 of the retention strap 80. Locating means may comprise various forms, which will be apparent to one skilled in the art. As shown in FIG. 1, locating means comprises a plurality of parallel slots 72 formed within the adjustment center 68 that are configured similarly to the slots 52 formed in the adjustment center 48 of the first tower 40. Each slot 72 is configured to facilitate the adjustment of the retention strap 80, or to provide a different locating position for the retention strap 80, along the adjustment center 68, thus allowing the retention strap 80 to be adjustably located along the adjustment center 68 of the tower 40 to accommodate different users or to provide selective securing conditions that are the most comfortable or appropriate for the user. For both the first and second towers 40 and 60, the locating means may also comprise various fasteners, such as snaps or a hook and loop fastener, or other configurations to releasably couple the retention strap 80.

The handle 14 is configured to receive and interface with the hand or extremity of a user, and is preferably ergonomically designed to improve the comfort and sensitivity of the user. The handle 14 provides the primary means for manipulating the adaptive wheelchair joystick 10 by a user capable of grasping the handle 14. However, the handle 14 may also be used simply as a rest for the hand or extremity of a user incapable of grasping the handle 14, in which case a retention strap 80 would most likely be implemented to secure the hand or extremity of the user, thus allowing the user to manipulate the adaptive wheelchair joystick 10 through a series of movements with the hand or extremity constrained by the first and second towers 40 and 60 and the retention strap 80. By securing the hand, the user is able to apply a pushing or pulling force to the first and second towers 40 and 60, as well as the retention strap 80, to manipulate the joystick 10 without having to grip the handle 14 for whatever reason, although gripping may further assist the user.

The interface of the adaptive wheelchair joystick 10 with a wheelchair is designed to take movements of the joystick and translate those into movements of the wheelchair. Indeed, by selectively manipulating the handle 14 (and/or through pushing and pulling on the first and second towers 40 and 60 and the retention strap 80), the wheelchair (not shown) is controlled to move in a forward direction, a backward direction, or caused to negotiate one or more turns. For example, the adaptive wheelchair joystick 10 may be designed so that the forward displacement of the joystick 10 by the user results in forward movement of the wheelchair, the rearward displacement of the joystick 10 by the user results in rearward movement of the wheelchair, and the turning or rotating the handle 14 in either direction results in the turning of the wheelchair in the corresponding direction. Thus, by interfacing the hand or extremity with the handle 14 and manipulating the displacement of the joystick 10, the user may be able to selectively control or negotiate the movement of the wheelchair. The type of interface the adaptive wheelchair joystick may have with the control components of the wheelchair is commonly known in the art, and may be similar to those used in prior related designs. However, while such an interface is contemplated for use, one skilled in the art may recognizer other ways of interfacing the adaptive wheelchair joystick of the present invention with a wheelchair. In any event, the specifics of such an interface, although intended for use by the present invention are not specifically described herein. Suffice it to say that the adaptive wheelchair joystick 10 of the present invention is configured to operate the controls of the wheelchair via a suitable interface.

The handle 14 may be comprised of any material and may comprise various geometric shapes and sizes. As shown in FIGS. 1 and 2, the handle 14 is linear along its length, comprises an elliptical cross-sectional shape, and is made of a rigid metal material. In other embodiments, the handle may comprise curved segments, such as curved segments in the form of finger guides configured to receive and position the fingers of the user. In addition, the surface 26 of the handle 14 may comprise some type of grip-improving surface to improve the grip of the user. In one aspect, the handle may have disposed thereon particles to improve the grip, as commonly known. In another aspect, the handle 14 may comprise a textured surface. In still another embodiment, the handle 14 may further comprise a separate grip, shown as grip 30, that is overlaid or disposed about the surface 26 of the handle 14. The grip 30 may be made of rubber or any other non-slip material known in the art. In addition, the handle may comprise a flat surface to accommodate the hand, wrist, or extremity of the user. Handles of various size, shape, texture, etc. are all contemplated herein.

First and second towers 40 and 60 are configured to provide securing support to the adaptive wheelchair joystick 10 upon the user inserting his or her hand or extremity therebetween and grasping the handle 14 or resting his or her hand or extremity on the handle 14. Thus, once a user's hand or extremity is in place, it is caused to be situated between the first and second towers 40 and 60. Any lateral movement of the user's hand, either voluntarily or involuntarily by the user, will result in limited or no displacement of the hand or extremity due to the presence of the towers, thus ensuring the user's hand or extremity stays on the handle 14 of the adaptive wheelchair joystick 10 and in a correct operating position. The distance of the first and second towers 40 and 60 apart from one another may vary as needed. In some embodiments, the first and second towers 40 and 60 are also configured to receive a lateral load or force as applied by the user to assist the user in manipulating the adaptive wheelchair joystick 10 to command the movement of the wheelchair. For example, the turning of the wheelchair may require the adaptive wheelchair joystick 10 to be pivoted downward left or right, depending upon the desired turning direction. By applying pressure to the first or second tower 40 or 60, the adaptive wheelchair joystick 10 may be pivoted downward left or downward right, thus executing the turn command. As such, first and second towers 40 and 60 function as assistive features that assist the user in manipulating the joystick and controlling the movements of the wheelchair.

First and second towers 40 and 60 may be formed of flexible or rigid materials, such as metal or plastic, or a combination of these. FIG. 2 illustrates flexible towers 40 and 60 in a flexed position, as represented by the dotted lines. In one aspect, with no retention strap employed, the towers 40 and 60 should not be too flexible so as to not be able to receive an applied force by the user to manipulate the joystick and execute a command. In addition, the towers 40 and 60 must not be too flexible so as to not permit the hand of the user from laterally sliding off the handle 14 either inadvertently or when trying to manipulate the joystick. In another aspect, with a retention strap employed, the first and second towers 40 and 60 may be as flexible as desired. The combination of the retention strap 80 with flexible towers 40 and 60 will prohibit unwanted lateral displacement of the user's hand, while still being capable of receiving a lateral force as applied by the user to manipulate the joystick. In other words, the combination of the retention strap 80 with flexible towers 40 and 60 will properly secure the user's hand and prevent it from slipping off of the handle 14, while also allowing the user to manipulate the joystick by applying pressure laterally along the joystick in either direction, and particularly to the coupled tower and retention strap.

First and second towers 40 and 60 are also configured to provide the means for securing the retention strap 80 in place, as well as for facilitating the selective adjustment of the retention strap 80 to one or more positions. As shown, the adjustment center 48 of the first tower 40 and the adjustment center 68 of the second tower 60 each comprise means for locating the retention strap 80 in one or more positions. As indicated, the means for locating may be any known in the art. In the embodiments of FIGS. 1 and 2, the adjustment centers 48 and 68 comprise means for locating in the form of a plurality of slots 52 and 72, respectively. Each of the adjustment centers 48 and 68 comprise four slots 52 and 72, respectively, that are parallel to one another and that are formed to comprise a through hole configured to receive the ends of the retention strap 80 therein and to facilitate the securing of the ends of the retention strap 80 to the respective first and second towers 40 and 60. Of course, as will be recognized by those skilled in the art, the adjustment centers of the first and second towers may comprise more or less slots.

One of the advantageous assistive features of the present invention adaptive wheelchair joystick 10 is the retention strap 80. The retention strap 80 is configured to facilitate the movement or manipulation of the handle 14 and the adaptive wheelchair joystick 10 as a whole by better securing the hand or extremity of the user using the joystick 10. In addition, the retention strap 80 is configured to decrease the likelihood that the user will slip off of the handle 14 inadvertently or while manipulating the adaptive wheelchair joystick 10 to operate the wheelchair. As so configured, the retention strap 80 functions as an assistive feature that reduces the level of dexterity required to manipulate the adaptive wheelchair joystick 10 as the user's hand or extremity within the joystick 10 is more securely retained, thus allowing the user to employ more of the body to manipulate the joystick rather than just hand movements. For example, by securing the hand, the user may be able to move the body and/or arm forward in an effort to move the adaptive wheelchair joystick forward. Adjusting the retention strap 80 will allow the user to control the degree to which his or her hand is secured to meet his or her level of ability.

In one exemplary embodiment, the retention strap 80 may be comprised of a non-stretching, inelastic material, such as leather, nylon, etc., that substantially limits the displacement of the user's hand when applying a directional force to the retention strap 80 during manipulation of the adaptive wheelchair joystick 10. In another exemplary embodiment, the retention strap 80 may be comprised of an elastic material, such as rubber, etc., that stretches to allow or provide some degree of displacement of the user's hand when applying a directional force to the retention strap 80 during manipulation of the adaptive wheelchair joystick 10. With an elastic composition, the retention strap still functions to secure the user's hand to the adaptive wheelchair joystick 10, but is less restrictive to allow some movement of the hand of the user.

FIGS. 1 and 2 illustrate retention strap 80 as having a first end 84 inserted through and releasably secured within the uppermost slot 52 of the adjustment center 48 of the first tower 40, and a second end 88 inserted through and releasably secured within the uppermost slot 72 of the adjustment center 68 of the second tower 60. In this connected configuration, the retention strap 80 is located in the furthest position from and in an orientation parallel to the handle 14. Other connection configurations are made possible by adjusting the retention strap 80 and inserting and securing the ends 84 and 88 to different slots 52 and 72, as will be shown and discussed in greater detail below. The ends 84 and 88 of the retention strap 80 are secured to the towers 40 and 60, respectively, using any releasable securing means known in the art, such as snaps, Velcro®, buckles, hooks, and others. In one exemplary embodiment, the ends 84 and 88 of the securing device 80 comprise rubberized protrusions formed thereon that fit through the slots 52 and 72 and that relax to couple or secure the ends 84 and 88 in place within the slots 52 and 72.

With the retention strap 80 secured in place, lift support is provided by the adaptive wheelchair joystick 10, meaning that the user's ability to lift his or her hand off the handle in an upward manner is limited. Indeed, the securing device 80 may be adjusted to be in contact with or against the user's hand so that any upward motion or lift of the hand is substantially prohibited (if the retention strap is inelastic) or substantially resisted (if the retention strap comprises some elastic properties). This connection configuration will help keep the user's hand on the handle 14, such as in the event the user needs assistance to do so. Alternatively, the retention strap 80 may be adjusted more loosely so that it is located in an offset position from the user's hand. The degree of offset may vary with each user and may also be adjusted as needed or desired. In an offset position, the retention strap 80 will provide the user with a limited degree of upward motion or displacement. In other words, with the retention strap 80 in an offset position, the user will be allowed to lift his or her hand from the handle 14 a limited, pre-determined distance until restricted by the retention strap 80. This connection configuration may be desirable in the event the user needs less assistance in maintaining a grip on the handle 14.

As another advantageous assistive feature, the adaptive wheelchair joystick 10 may further comprise a thumb rest 100 for receiving and supporting the thumb of the user. Thumb rest 100 extends from either of the first or second ends 18 and 22 of the handle 14 depending upon the hand preference of the user (i.e., whether the user is right or left handed). Alternatively, the handle 14 may be manufactured having two thumb rests, one at each of the first and second ends 18 and 22, thus allowing the adaptive wheelchair joystick 10 to be interchanged to accommodate right or left handed users. A first thumb rest 100 is shown in FIG. 1, as well as a second thumb rest 100 shown in dotted lines indicating its optional inclusion. The thumb rest 100 functions to receive and support the thumb of the user during operation or manipulation of the adaptive wheelchair joystick 10. The thumb rest 100 provides increased operational sensitivity and comfort to the user as it allows the hand of the user to assume a more ergonomically correct operating position, or functional position, within or on the adaptive wheelchair joystick 10. The thumb rest 100 is configured to assist the user in controlling or manipulating the adaptive wheelchair joystick 10 by allowing the user to apply pressure to the thumb rest 100, which pressure is independent of that applied to the handle 14. In effect, the thumb rest 100 improves or increases the leverage available to the user to manipulate the adaptive wheelchair joystick 10. The leverage is increased by the fact that thumb rest 100 extends outward from the handle 14, which extension functions to increase the contact distance away from a center point of the handle 14. Stated another way, the thumb rest 100 provides the ability for additional forces to be applied to the adaptive wheelchair joystick 10 by the user other than those applied through the handle 14. Without the thumb rest 100, the user is confined to manipulation of the joystick solely by the manipulation of the handle 14. This may be the case in some embodiments. However, the addition of the thumb rest 10 to the adaptive wheelchair joystick 10 provides the user with multiple means for applying controlling forces and manipulating the adaptive wheelchair joystick 10. As such, control is made more sensitive and more natural for users. Other advantages of the thumb rest will be apparent to those skilled in the art.

The thumb rest 100 may comprise many different configurations or designs. In the exemplary embodiment shown in FIG. 2, the thumb rest 100 comprises a curved face segment 104 that extends outward from the end 18 of the handle 14 and curves slightly toward the user. Integrally formed with the face 104 is a depression or undulation 108 wherein the thumb of a user ultimately comes to rest. The undulation 108 is situated in a plane slightly lower than a plane in which the handle 14 is situated, thus representing a comfortable and ergonomically correct configuration. The configuration of the thumb rest 100 shown in FIG. 2 is not meant to be limiting in any way. Indeed, other configurations are contemplated herein, and will be apparent to those skilled in the art.

Moreover, in one embodiment the thumb rest 100 may be fixed to or integrally formed with the handle 14. In another embodiment, the thumb rest 100 may be removably coupled or detachable from the handle 14 using any known coupling or attaching means, such as a screw-on configuration, an interference fit, a snap-on configuration, and others. If removably coupled, the thumb rest 100 may be interchangeably attached to the first and second ends 18 and 22 of the handle 14, depending upon the hand preference of the user.

FIG. 2 also illustrates means for operably coupling the joystick to the control components of the wheelchair in the form of a stem 110 as formed with or coupled to the handle 14. The stem 110 is configured to physically interface with the control components of the wheelchair and to secure the adaptive wheelchair joystick 10 to a wheelchair. The stem 110 may be of any suitable size and configuration, as dependent upon the components of the wheelchair to which it is being connected. In addition, the present invention may comprise means for adjusting the stem. Means for adjusting the stem may comprise any means known in the art capable of facilitating the height of the stem 110, and therefore the adaptive wheelchair joystick 10, to be adjusted as needed. In one exemplary embodiment, as shown, means for adjusting the stem 110 comprises a plurality of adjustment apertures 114 formed about the stem 110, as well as a biased insert 124 located or supported within a collar 120, wherein the biased insert 124 is configured to selectively engage the adjustment apertures 114, thus allowing a pre-determined height of the adaptive wheelchair joystick 10 to be achieved. To lower or raise the adaptive wheelchair joystick 10, the biased insert 124 is caused to disengage the presently engaged adjustment aperture 114 and to subsequently engage a different adjustment aperture 114 of a different height. The collar 120 is also configured to be supported by the control components of the wheelchair and to receive the stem 110 of the adaptive wheelchair joystick 10 in a releasable manner.

Other means for operably coupling the joystick to the control components of the wheelchair may include multiple stems, or any other type of structure that is configured to support the joystick 10 on the wheelchair and that functions as the physical connector between the handle 14 of the adaptive wheelchair joystick 10 and the control components of the wheelchair. Such other embodiments will be obvious to those skilled in the art, and are contemplated herein.

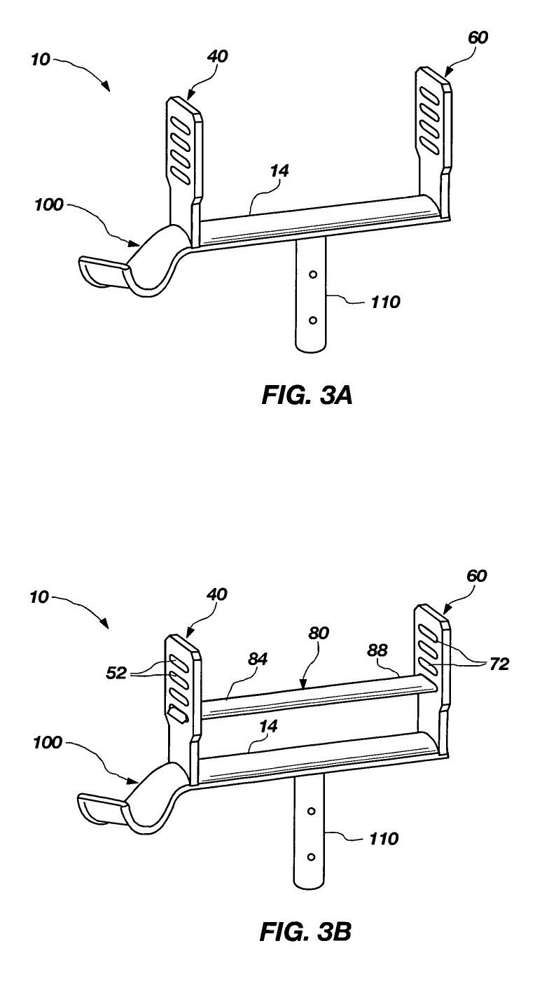

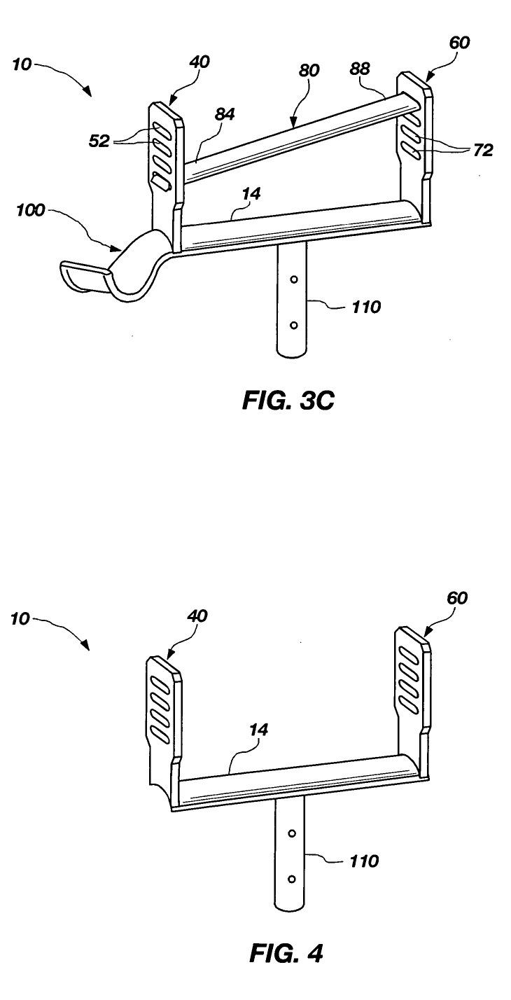

FIG. 3-A illustrates a perspective view of an adaptive wheelchair joystick according to another exemplary embodiment of the present invention. In this embodiment, the adaptive wheelchair joystick 10 comprises a handle 14, first and second towers 40 and 60, respectively, a stem 110, and a thumb rest 100. As a retention strap is optional in some embodiments, there is no retention strap included here. Instead, the first and second towers 40 and 60 are formed of a rigid material to secure the user's hand about the handle 14 and to prevent it from slipping off of the handle 14 during operation in response to lateral pressure voluntarily or involuntarily applied by the user's hand. Without the retention strap, the first and second towers 40 and 60 function as the only means for laterally securing the user's hand within the adaptive wheelchair joystick 10. Also, in the absence of a retention strap to facilitate manipulation of the adaptive wheelchair joystick 10, the thumb rest 110 is included, which functions to assist the user in manipulating the adaptive wheelchair joystick 10 as described above. The elimination of a retention strap may be desirable for those with greater dexterity or physical abilities.

FIG. 3-B illustrates a perspective view of the adaptive wheelchair joystick 10 of FIG. 2 having a retention strap 80 located in its lowest position between the first and second towers 40 and 60. In this position, the retention strap 80 is caused to be close to or in contact with the user's hand upon inserting it between the first and second towers 40 and 60, thus reducing the available movement of the user's hand within the adaptive wheelchair joystick 10 and about the handle 14, while increasing the sensitivity of the adaptive wheelchair joystick 10 to movement of the user's hand. In this configuration, the retention strap 80 functions to more aggressively secure the user's hand within the adaptive wheelchair joystick 10 and to further prevent inadvertent slipping off of the adaptive wheelchair joystick 10.

Moreover, in this embodiment, the retention strap 80 is used in combination with the thumb rest 100. Using the retention strap 80 in combination with the thumb rest 100, and particularly the retention strap 80 in its lowest position, provides ultimate control over and increased sensitivity within the adaptive wheelchair joystick 10 by reducing the available non-commanding movements of the user's hand. In other words, in this embodiment, even slight movements of the user's hand can be made to result in manipulation of the adaptive wheelchair joystick 10 and execution of a command to control the movement or turning of the wheelchair as the ability to move the hand within the adaptive wheelchair joystick 10 without manipulating the joystick is substantially reduced.

FIG. 3-C illustrates a perspective view of the adaptive wheelchair joystick 10 of FIG. 2 having a retention strap 80 positioned between the first and second towers 40 and 60 so as to be on an angle with respect to the handle 14. In this embodiment, the end 84 of the retention strap is placed in an adjusting slot 52 so as to be below the second end 88 of the retention strap 80, as placed within an adjusting slot 72. With the retention strap 80 positioned in an angled orientation, the user's hand is still easily inserted between and removed from the first and second towers 40 and 60. This advantage is combined with that discussed above with respect to FIG. 3-B, in that greater sensitivity is provided within the adaptive wheelchair joystick 10 in response to movement of the user's hand.

Again, in this embodiment the retention strap 80 is used in combination with the thumb rest 100 to provide improved control over the manipulation of the adaptive wheelchair joystick 10.

FIG. 4 illustrates a perspective view of an adaptive wheelchair joystick according to still another exemplary embodiment of the present invention. In this embodiment, the adaptive wheelchair joystick 10 features a handle having first and second towers 40 and 60 extending therefrom as discussed above. As shown, adaptive wheelchair joystick 10 comprises neither a retention strap nor a thumb rest. This is a basic configuration and will result in manipulation of the adaptive wheelchair joystick 10 solely through the handle 14 and application of pressure to the first and second towers 40 and 60. Users of this configuration will not be too concerned with slippage over the towers or sensitive response to hand movements as other assistive features of the retention strap and the thumb rest are not included.

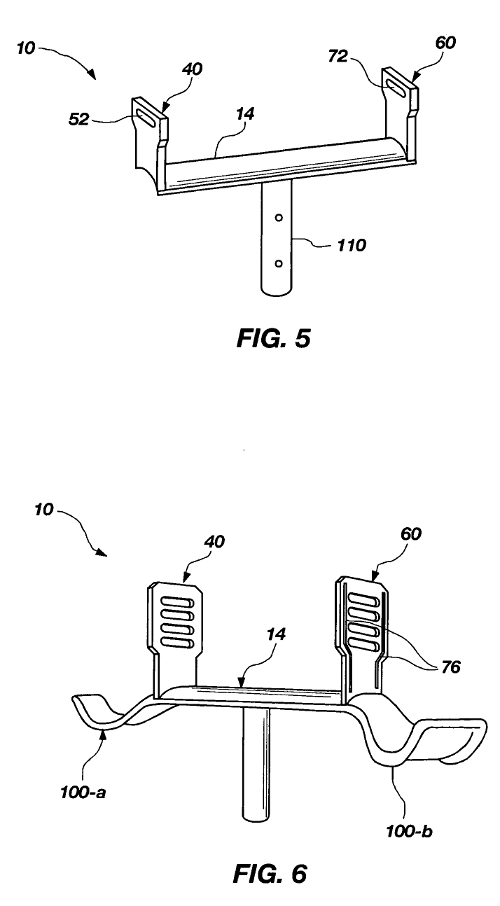

FIG. 5 illustrates a perspective view of an adaptive wheelchair joystick 10 according to still another exemplary embodiment of the present invention, wherein the first and second towers 40 and 60 comprise a lower overall height and only one or a lesser number of adjustment slots 52 and 72, respectively, than the adaptive wheelchair joystick embodiments discussed above. Shortening the first and second towers 40 and 60 caters to those individuals or users that do not require a great amount of assistance from the towers to manipulate the joystick. In addition, lower towers are less likely to interfere with or get caught on objects as the user negotiates movements of the wheelchair.

FIG. 6 illustrates a perspective view of an adaptive wheelchair joystick 10 according to still another exemplary embodiment of the present invention, wherein the first and second towers 40 and 60 comprise additional stiffening members 76. Stiffening member 76 are configured to increase the overall stiffness of the first and second towers 40 and 60. Any number of stiffening members 76 may be used and placed in any orientation about the surfaces of the first and second towers 40 and 60. Stiffening members 76 may comprise any stiffness ratio, may be any size, and may exist in any number. Applying stiffness members 76 to the first and second towers 40 and 60 functions to increase their inherent stiffness, thus increasing their sensitivity to any lateral forces applied thereto by the user. In addition, stiffness members 76 may be removably coupled or detachable. Thus, their application will largely depend upon the abilities of the user of the wheelchair and may be altered for different users. In the embodiment shown, first and second towers 40 and 60 comprise multiple stiffening ridges 76 that are oriented longitudinally about the first and second towers 40 and 60.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are expressly recited. Accordingly, the scope of the invention should be determined solely by the appended claims and their legal equivalents, rather than by the descriptions and examples given above.

What is claimed and desired to be secured by Letters Patent is:

1. An adaptive wheelchair joystick comprising:
means for operably coupling said joystick to the control components of a motorized wheelchair;
a handle operable with said means for coupling, said handle configured to support an extremity of a user of said wheelchair and to facilitate manipulation of said adaptive wheelchair joystick;
at least one tower extending from said handle, said tower providing lateral support for said extremity of said user; and
a thumb rest extending from said handle and configured to receive and support a thumb of said user, said thumb rest also facilitating the manipulation of said adaptive wheelchair joystick.

2. The adaptive wheelchair joystick of claim 1, wherein said means for operably coupling comprises a stem.

3. The adaptive wheelchair joystick of claim 2, wherein said stem is configured to be adjustable to vary a height of said handle with respect to a portion of said wheelchair.

4. The adaptive wheelchair joystick of claim 1, wherein said handle comprises a grip-improving surface.

5. The adaptive wheelchair joystick of claim 1, wherein said handle comprises an ergonomic design.

6. The adaptive wheelchair joystick of claim 1, wherein said handle is configured with a flat surface to assist in the support of said extremity.

7. The adaptive wheelchair joystick of claim 1, wherein said thumb rest is removably coupled to said handle.

8. The adaptive wheelchair joystick of claim 1, wherein said thumb rest is attachable to either end of said handle to accommodate left or right hand users.

9. The adaptive wheelchair joystick of claim 1, further comprising means for securing said extremity.

10. The adaptive wheel chair joystick of claim 9, wherein said means for securing comprises a retention strap configured to extend over said extremity.

11. The adaptive wheelchair joystick of claim 10, wherein said retention strap is configure to couple to at least one of said handle and said at least one tower.

12. An adaptive wheelchair joystick comprising:
means for operably coupling said joystick to the control components of a motorized wheelchair;
a handle operable with said means for coupling, said handle configured to support an extremity of a user of said wheelchair and to facilitate manipulation of said adaptive wheelchair joystick;
a first tower extending from a first end of said handle;
a second tower extending from a second end of said handle, said first and second towers providing lateral support to said extremity of said user; and
a retention strap operable with said handle and said first and second towers to restrict the upward lift of said extremity of said user and to alter the sensitivity of said joystick in response to movements to said joystick by said user.

13. The adaptive wheelchair joystick of claim 12, wherein said retention strap is secured between said first and second towers.

14. The adaptive wheelchair joystick of claim 12, wherein said retention strap is secured between said handle and at least one of said first and second towers.

15. The adaptive wheelchair joystick of claim 12, wherein said retention strap is releasable.

16. The adaptive wheelchair joystick of claim 12, wherein said retention strap is at least partially elastic.

17. An adaptive wheelchair joystick comprising:
means for operably coupling said joystick to the control components of a motorized wheelchair;
a handle operable with said means for coupling, said handle configured to support an extremity of a user of said wheelchair and to facilitate manipulation of said adaptive wheelchair joystick;
a first tower extending from a first end of said handle;
a second tower extending from a second end of said handle, said first and second towers providing lateral support to said extremity of said user;
a retention strap operable with said handle and said first and second towers to restrict the upward lift of said extremity of said user and to alter the sensitivity of said joystick in response to movements to said joystick by said user; and
a thumb rest extending from said handle and configured to receive and support a thumb of said user, said thumb rest also being configured to facilitate the manipulation of said adaptive wheelchair joystick.

18. A method for controlling the movements of a motorized wheelchair comprising:
coupling an adaptive wheelchair joystick to the control components of a motorized wheelchair;
interfacing an extremity with a handle of said adaptive wheelchair joystick located between first and second towers extending from said handle;
securing a retention strap between said first and second towers to restrict the upward lift of said extremity of a user and to provide a degree of sensitivity to said adaptive wheelchair joystick in response to movements to said adaptive wheelchair joystick by said user; and
manipulating said handle in a variety of ways to initiate a command to said control components, said command causing said wheelchair to move in an intended, pre-determined manner.

19. The method of claim 18, further comprising providing a thumb rest extending from an end of said handle, said thumb rest being configured to receive and support a thumb of said user and to facilitate the manipulation of said adaptive wheelchair joystick.

20. The method of claim 18, further comprising adjusting said retention strap to alter said sensitivity of said adaptive wheelchair joystick in response to the movements of said hand of said user.
